(19) United States
(12) Patent Application Publication
(10) Pub. No.: US 2025/0020085 A1
(43) Pub. Date: Jan. 16, 2025

(54) METHOD FOR OPERATING A GAS-POWERED INTERNAL COMBUSTION ENGINE

(71) Applicant: AVL LIST GMBH, Graz (AT)

(72) Inventor: Admir Zukancic, Graz (AT)

(21) Appl. No.: 18/713,325

(22) PCT Filed: Dec. 13, 2022
(86) PCT No.: PCT/AT2022/060435

§ 371 Date: May 24, 2024

(30) Foreign Application Priority Data
Dec. 13, 2021 (AT) A 50993/2021

(51) Int. Cl. F02D 17/02; F02D 19/02; F02D 41/00

(52) U.S. Cl. CPC F02D 17/02; F02D 19/02; F02D 41/0027

(57) ABSTRACT

The invention relates to a method for operating a gas-powered internal combustion engine, wherein during a switched on operating state of the internal combustion engine, an oxygen-containing gas, preferably air, is introduced during an inflow phase into at least one cylinder for combustion and wherein fuel is fed to at least one injector, is injected by the injector into the cylinder in the course of a primary injection and is ignited there in the course of a primary ignition, characterised in that the supply of fuel to the injector is ended during a switch-off process of the internal combustion engine, and in that fuel remaining in the region of the injector is injected into at least one cylinder of the internal combustion engine after the primary ignition and before the start of the subsequent inflow phase in the course of a secondary injection and is ignited in the course of a secondary ignition.

The invention relates to a method for operating a gas-powered internal combustion engine, wherein during a switched-on operating state of the internal combustion engine, an oxygen-containing gas, preferably air, is introduced during an inflow phase into at least one cylinder for combustion and wherein fuel is fed to at least one injector, is injected by the injector into the cylinder in the course of a primary injection and is ignited there in the course of a primary ignition.

It is known that in gas-powered internal combustion engines, i.e. internal combustion engines that are operated with a fuel that is gaseous under normal atmospheric conditions, for example hydrogen, natural gas and the like, a residual proportion of fuel remains in the injectors and/or the lines supplying the injectors after shutdown. After the end of the switched-on operating state, there is therefore residual fuel that is present at high pressure in the injectors and/or via the supply lines of the injectors. In order to reduce the resulting pressure in these parts during the switched-off state, the remaining gas is either released into the environment or transferred to corresponding collection containers after the last regular combustion in the course of primary ignition. This leads either to the problem that the environment is polluted by the fuel and the flammable gas represents a safety risk, or to a complex design due to additional components.

DE 10 2015 210 756 A1, EP 3 486 458 A1 and JP 2004076698 A discuss methods that consume the remaining fuel in the injector during a switch-off process in the course of the primary injections during the inflow phase and the primary ignitions and thus continue to drive the internal combustion engine for a few more revolutions. Due to the decreasing amount of fuel in the injector and the resulting decreasing pressure in the injector, the injection quantity into the cylinder becomes increasingly smaller. This can cause the primary ignitions to fail, as the small amount of fuel injected is diluted too much by the incoming air in the inflow phase. As a result, unburned fuel can escape into the environment.

It is therefore the object of the invention to provide a method which is as safe and environmentally friendly as possible and which requires a simple design.

This object is solved in accordance with the invention in that the supply of fuel to the injector is terminated during a switch-off process of the internal combustion engine, and in that fuel remaining in the region of the injector is injected into at least one cylinder of the internal combustion engine after the primary ignition and before the start of the subsequent inflow phase in the course of a secondary injection and is ignited in the course of a secondary ignition.

This allows the remaining fuel to be removed and the injector or injectors to be relieved without it being released into the environment or having to be stored separately. No major technical adjustments or more complex designs are required to carry out this method and yet it ensures that no unburned fuel reaches the outside world and poses an environmental risk or even ignites in an uncontrolled manner.

It is not essential that all the remaining fuel is injected and ignited, but that the pressure of this remaining fuel in the relevant parts is reduced, in particular to ambient pressure. This prevents any danger from escaping fuel, especially hydrogen, when the internal combustion engine is switched off.

This further ignition, i.e. secondary ignition, outside the normal ignition cycle of the switched-on operation ensures that the fuel is burned without significantly disturbing the outgoing movements of the internal combustion engine. This secondary ignition preferably exerts only a negligible or no force on the piston; there is preferably no downward movement (or inhibition of the upward movement) of the piston induced by the secondary ignition, as is the case with primary ignition. The internal combustion engine is therefore not stressed by this additional ignition.

Preferably, the supply of fuel to the injector is terminated during the switch-off process and only then is the fuel remaining in the area of the injector, in particular in a distribution device, injected and ignited.

This refers to the remaining fuel that is still in the supply lines to the injectors and in the injector itself at the end of the fuel supply to the injectors. As a rule, the injector or injectors are supplied with fuel via a pressure-reducing device, a so- called pressure regulator. Preferably, a line system is provided for supplying the injector or injectors, wherein the line system has at least one pressure-reducing device. This pressure-reducing device is used to reduce the pressure of the fuel from the fuel source, such as a fuel tank, and to supply it to the injectors at a lower pressure. Preferably, the fuel remaining between the at least one pressure regulator and the injector is injected and ignited during the shut-off process in accordance with the invention.

Furthermore, the line system can also have distribution devices for distributing the fuel between the injectors.

The inflow phase is a phase in which an intake port is connected to the combustion chamber, i.e. the cylinder interior, and air or another oxygen-containing gas flows into the combustion chamber. The gas can be precompressed and/or mixed with additives, for example fuel, nitrogen or other gases, liquids or solids. This flow connection can take place, for example, by opening at least one valve and/or by moving the piston and thus releasing at least one channel opening. In the case of a valve opening, the inflow phase therefore begins with the start of the valve opening and ends with the end of the valve closing. The same applies to the movement-induced uncovering of the channel openings.

When switched on, the primary ignition is used to exert force on the piston in order to drive it towards bottom dead center. As a rule, primary ignition takes place at or at least in the immediate vicinity of top dead center.

Internal combustion engines for the aforementioned method are usually used to operate a vehicle, in particular to drive it.

In the switched-on operating state, the engine is operated normally in order to provide torque, for example for a vehicle, in particular for its locomotion. This is therefore the normal operation of the internal combustion engine, in which fuel is continuously burned and the piston(s) are thus moved cyclically from top dead center to bottom dead center and vice versa.

If the internal combustion engine is to be transferred from the switched-on operating state to an idle state, i.e. a switched-off state, for example when the vehicle is parked, a switch-off process is carried out in which the switched-on operating state is exited and the internal combustion engine stops providing relevant torque for locomotion. As a rule, the exact sequence of the switch-off process is defined by the program of an engine control unit, which initiates the switch-off process when a corresponding user request is received, for example. During this process, the regular injection and combustion in the course of the primary ignition of the fuel to generate torque is terminated, as this is no longer required. The pistons can still perform a few revolutions or partial revolutions until they come to a standstill. The pistons therefore still move at least partially through the individual phases such as the inflow phase or the exhaust phase, even if perhaps not all actively controlled activities such as primary injection or primary ignition are no longer taking place. However, the flow connections with the intake and exhaust ducts usually take place when moving through the intake and exhaust phases due to the mechanical control of the valves or the uncovering of flow openings during the switch-off process.

Preferably, it is provided that, in a switched-on operating state of the internal combustion engine, exhaust gas is discharged from the cylinder during an exhaust phase, and that the remaining fuel is injected and ignited at or after the start of the exhaust phase and preferably in the exhaust phase and particularly preferably in the first half of the exhaust phase. This enables the burnt gas to escape from the combustion chamber directly after secondary ignition and prevents an increase in pressure in the combustion chamber during secondary ignition, which would unintentionally influence the movement of the piston. It may also be provided that the remaining fuel is injected and preferably also ignited at least 10° crank angle before the end of the exhaust phase, preferably at least 20° crank angle before the end of the exhaust phase.

The exhaust phase is a phase in which at least one exhaust duct is flow-connected to the combustion chamber, i.e. the cylinder interior, and exhaust gas can flow out of the combustion chamber. This flow connection can take place, for example, by opening at least one valve and/or by moving the piston and thus releasing at least one duct opening. In the case of a valve opening, the exhaust phase therefore begins with the start of the valve opening.

The exhaust phase and the inflow phase can overlap or the inflow phase can even coincide with the exhaust phase. This is possible in 2-stroke operation in particular, but also in 4-stroke operation.

The first half refers to the first half in terms of time. Injection in the first half ensures that there is enough space in the cylinder to achieve ignition without significantly affecting the movement of the piston.

In a preferred embodiment, it is provided that the ignition of the remaining fuel takes place at a maximum crank angle of 20° after the start of the injection of the remaining fuel, preferably at a maximum crank angle of 10° after the start of the injection of the remaining fuel. This ensures that the remaining fuel can distribute itself in the combustion chamber and mix with the oxygen there before it is ignited without too much time being lost. This leads to the most complete combustion possible without impairing the movement of the piston.

Preferably, ignition of the remaining fuel takes place at least 5° crank angle after the start of injection.

It may be provided that a pressure regulator directs fuel from a fuel tank at a set pressure via a distribution device to a plurality of injectors and that during the shut-off process the pressure regulator terminates the fuel supply to the distribution device, preferably before the remaining fuel is injected and ignited. This enables the fuel pressure to be set correctly during injection. In the distribution device, a pressure is set by the pressure regulator during the switched- on operating state, which leads to the desired injection pressure in the cylinder. During the switch-off process, this pressure is reduced again by the secondary injection and ignition.

In this sense, it is advantageous if the pressure of the fuel is reduced by the pressure regulator during the switched-on operating state. This means that there is a higher pressure upstream of the pressure regulator than downstream of the pressure regulator, i.e. the pressure regulator reduces the pressure along the direction of flow of the fuel. In other words, the pressure regulator reduces the pressure of the fuel during operation so that the pressure in the fuel tank is higher than the pressure in the distribution device. The pressure regulator can thus be set up easily and the fuel can be stored at high pressure. This enables an efficient and space-saving solution, in which the pressure at the injector is nevertheless optimally adjusted.

In this sense, it is also advantageous if, during the switch-off process of the internal combustion engine, fuel located in the distribution device and/or the injectors is injected into at least one cylinder of the internal combustion engine after primary ignition and before the start of the subsequent inflow phase and is ignited. In this way, the pressure of the fuel in the injectors or the distribution device is reduced.

It is particularly advantageous if the internal combustion engine is operated in a four-stroke mode, that in the switched-on operating state during an intake stroke an oxygen-containing gas, preferably air, is introduced into the cylinder and fuel is fed into the cylinder, and that during the switch-off process the remaining fuel is injected into at least one cylinder of the internal combustion engine before the start of the intake stroke and is ignited. The intake stroke usually begins in the area of top dead center and usually ends in the area of bottom dead center. The inflow phase therefore corresponds to the intake stroke in four-stroke operation.

In four-stroke operation, the gas is preferably ignited in a power stroke during primary ignition when the internal combustion engine is switched on.

The power stroke is the stroke at which the regular ignition takes place, which drives the cylinder towards bottom dead center. As a rule, the power stroke begins at a crank angle of 0°, i.e. top dead center, and ends at 180°, i.e. bottom dead center.

It may be provided that in the switched-on operating state exhaust gas is discharged from the cylinder at the beginning or during an exhaust stroke and that, during the switch-off process, the remaining fuel is injected into at least one cylinder of the internal combustion engine before the end of the exhaust stroke and is ignited. This ensures that the exhaust gas produced by the secondary ignition is also completely discharged so that the combustion chamber is ready for primary ignition again when the engine is restarted.

The exhaust stroke is the stroke that generally follows directly after the power stroke and during which the burnt gas in the combustion chamber is expelled. Preferably, the exhaust stroke begins at a crank angle of 180°, i.e. bottom dead center, and ends at 360°, i.e. top dead center. As a rule, at least one exhaust valve is open during the power stroke, which establishes a flow connection between the combustion chamber and an exhaust duct through which the gas can escape.

It is also advantageous if, during the switch-off process, the remaining fuel is injected and ignited at or after a crank angle of 30° before the start of the exhaust stroke, preferably at or after a crank angle of 20° before the start of the exhaust stroke. This allows a sufficient distance to the last primary ignition, but provides enough time and space for the injectors to be relieved as completely as possible.

It is may also be provided that the internal combustion engine is operated in a two-stroke mode.

In this sense, it may be provided that, in a switched-on operating state of the internal combustion engine, exhaust gas is discharged from the cylinder during an exhaust phase, and that, during the switch-off process, injection of the remaining fuel begins at or after a crank angle of 15° before the start of the exhaust phase, preferably at the earliest at or after a crank angle of 5° before the start of the exhaust phase and particularly preferably at or after the start of the exhaust phase. In two-stroke operation, less time is available for venting the injectors, but this choice of timing for injection still makes it possible without impairing the movement of the piston.

The last ignition during operation of the internal combustion engine of the cylinder in which fuel remaining during the switch-off process is injected and ignited is preferably carried out in an over-stoichiometric ignition mixture, i.e. with an ignition mixture in which more air is present than would be necessary to burn the fuel completely, i.e. a lean ignition mixture.

If a plurality of cylinders are provided, at least one cylinder is preferably selected for the injection and ignition of the remaining fuel, which is located in the possible described areas for the injection and ignition of the remaining fuel at the start of the switch-off process and/or is located directly in front of these areas. This allows the pressure to be reduced as soon as possible after the switch-off signal.

It is particularly preferable to select at least one cylinder for the injection and ignition of the remaining fuel, which is located directly after the end of the fuel line to the injector in the possible areas described for the injection and ignition of the remaining fuel and/or is located directly in front of these areas. This allows the shut-off process to be kept as short as possible and the pressure applied to the injectors to be reduced to a minimum.

In the following, the invention is explained with reference to non-limiting embodiments according to the invention in the figures, wherein:

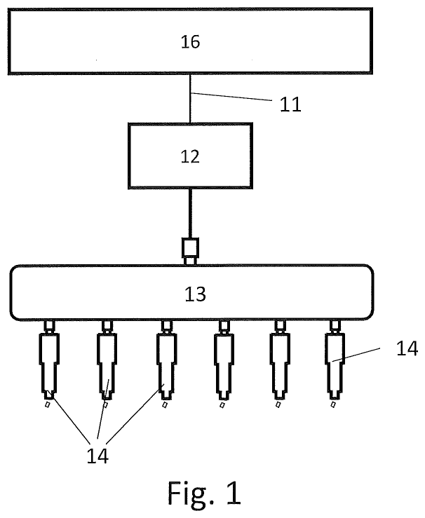

FIG. 1 shows a schematic structure of a fuel line of an internal combustion engine for the implementation of a method according to the invention in a first embodiment;

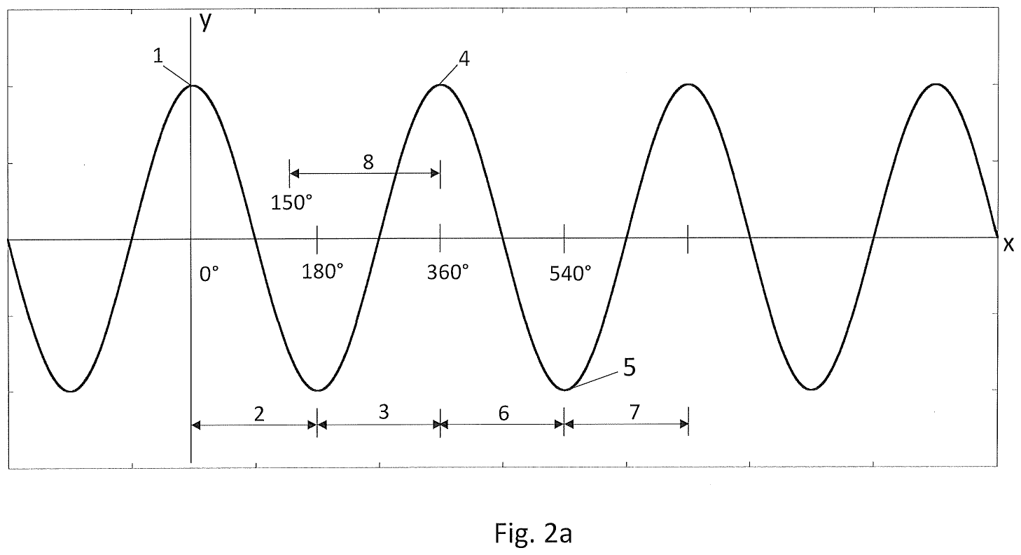

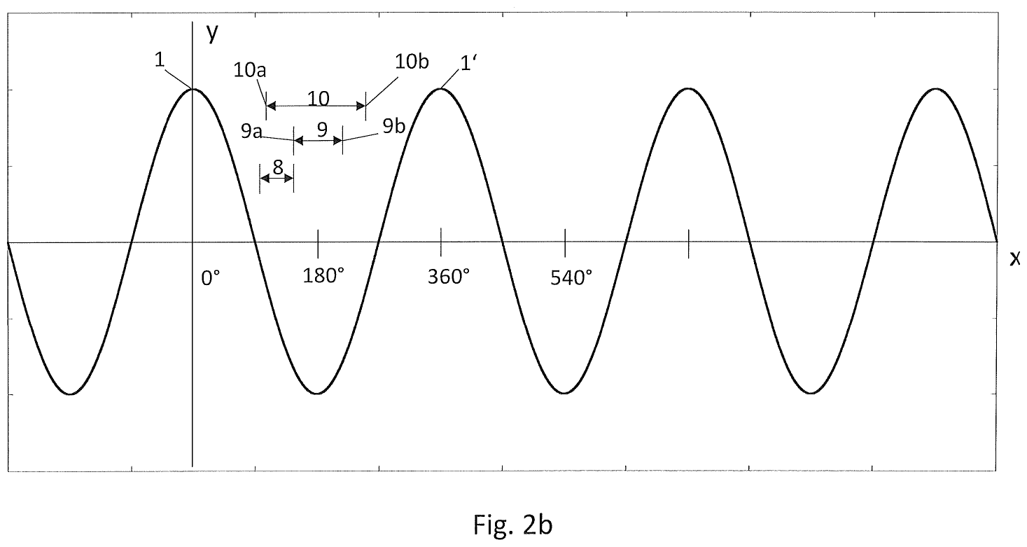

FIG. 2a shows a schematic representation of the piston position in a cylinder of an internal combustion engine during implementation of a method according to the invention in a second embodiment as a function of the crank angle in a four-stroke operation;

FIG. 2b shows a schematic representation of the piston position in a cylinder of an internal combustion engine during implementation of a method according to the invention in a third embodiment as a function of the crank angle in two-stroke operation.

A fuel supply system for an internal combustion engine with six cylinders is shown schematically in FIG. 1. The fuel is stored in a gas tank 16 under high pressure. A line 11 connects the gas tank 16 to a pressure regulator 12, which feeds fuel into a distribution device 13 connected to it during operation of the internal combustion engine, wherein the pressure regulator 12 throttles the pressure of the forwarded fuel. The pressure regulator 12 can, for example, be designed as an adjustable valve.

The distribution device 13 is connected to six injectors 14, each of which is assigned to a cylinder. It may also be provided that at least two injectors 14 are assigned to at least one cylinder. During operation, the pressure regulator 12 can be used to set the pressure at which the fuel is applied to the injectors 14 and thus the pressure at which the fuel enters the cylinder during injection.

FIG. 2a shows the piston position y in a cylinder of the internal combustion engine between top and bottom dead center depending on the crank angle x of the crankshaft. At a crank angle of 0°, the piston is at top dead center. In the area of this top dead center, preferably at top dead center, the primary ignition 1 takes place, which ignites the previously introduced and compressed air-fuel mixture and thus drives the piston downwards. This power stroke 2, which extends from 0° to 180° crank angle, is followed by an exhaust stroke 3, during which an exhaust valve of the cylinder is open and the burnt gas can flow out. Meanwhile, the piston moves back towards top dead center 4 at 360°, where no primary ignition takes place. The first revolution of the crankshaft and the exhaust stroke 3 ends there and the exhaust valve closes, ending the exhaust stroke 3. At the same time, an intake valve opens so that compressed air can preferably flow into the cylinder, while the piston moves back towards bottom dead center 5 during the second revolution. There, the intake valve closes again and the intake stroke 6, which extends from the beginning of the opening to the end of the closing of the intake valve, is completed. During this intake stroke 6, fuel is also injected by the injector 14 when the engine is running. The intake stroke 6 is followed by a compression stroke 7, which extends from bottom dead center to top dead center, where the next primary ignition and thus the next power stroke starts.

During the switch-off process, the primary ignitions and fuel injections are terminated, which means that the pistons are no longer pressed down in the power stroke. Shortly after termination, the pistons make a few more movements due to the momentum and the valves open and close accordingly. In addition, the pressure regulator 12 is also closed during the switch-off process.

As soon as the pressure regulator is closed, the fuel remaining between the pressure regulator 12 and the injector or injectors 14 within window 8 is injected into the cylinder or cylinders that are currently in the power stroke and/or are currently in window 8. This secondary injection or secondary injections reduce the pressure in the distributor device 13.

In this embodiment, the window 8 for the injection of the remaining fuel begins 30° before the start of the exhaust stroke, i.e. at a crank angle of 150°, during the last power stroke of the cylinder. It ends with the closing of the exhaust valve and thus with the end of the exhaust stroke 3. Preferably, the ignition of this remaining fuel takes place 20° or particularly preferably 10° after its injection, so that the fuel can be distributed in the cylinder chamber. In this sense, it is advantageous if the injection takes place at the latest 20° crank angle and preferably 10° crank angle before the end of the exhaust stroke 3.

In FIG. 2b, the piston position between top and bottom dead center is shown as a function of the crank angle of the piston in a cylinder of the internal combustion engine in a further embodiment, which is similar to that in FIG. 2a. Therefore, only the most important differences are discussed here and identical features are marked with the same reference sign.

The internal combustion engine described in FIG. 2b is operated in two-stroke mode with cross-flow scavenging. Primary ignition 1 takes place at top dead center, i.e. at a crank angle of 0°. During the downward movement of the piston towards bottom dead center (at 180°), the piston exposes an opening or openings, creating a flow connection between an exhaust duct in the cylinder and its combustion chamber. This is illustrated by point 9a. From this point onwards, an exhaust phase 8 begins, during which the burnt gas can escape from the combustion chamber.

As the piston continues to move downwards, it exposes a further opening or openings, creating a flow connection between an intake duct and the combustion chamber. This allows air, preferably precompressed in the crankcase, to enter the combustion chamber. This point in time is shown as point 10a and represents the start of an inflow phase 10 during which fresh air can enter the combustion chamber.

Accordingly, after passing bottom dead center, the piston first ends the flow connection to the inlet port (point 10b) and thus first ends the inflow phase 10 and then the exhaust duct is closed (point 9b) and the exhaust phase 9 is ended. After the piston has reached top dead center again, the next primary ignition 1′ takes place in switched-on operation.

The shut-off process is initiated as described in FIG. 2a. As soon as the pressure regulator 12 is closed, the fuel remaining between the pressure regulator 12 and the injector or injectors 14 is injected into the cylinder or cylinders that are located between a primary ignition 1 and window 8 and/or in window 8. This secondary injection or secondary injections reduce the pressure in the distributor device 13. In this embodiment, window 8 starts at a crank angle of 15° before the start (point 9a) of the exhaust phase 9 and ends at the start (point 10a) of the inflow phase 10.

1. A method for operating a gas-powered internal combustion engine, wherein during a switched-on operating state of the internal combustion engine, an oxygen-containing gas, preferably air, is introduced during an inflow phase into at least one cylinder for combustion and wherein fuel is fed to at least one injector, is injected into the at least one cylinder by the at least one injector in the course of primary injection and is ignited there in the course of a primary ignition, wherein the supply of fuel to the at least one injector is terminated during a switch-off process of the internal combustion engine, and wherein fuel remaining in the region of the at least one injector is injected into at least one cylinder of the internal combustion engine after the primary ignition and before the start of the subsequent inflow phase in the course of a secondary injection and is ignited in the course of a secondary ignition.

2. The method according to claim 1, wherein, in a switched-on operating state of the internal combustion engine, exhaust gas is discharged from the at least one cylinder during an exhaust phase, and wherein the remaining fuel is injected and ignited during the switch-off process at the start of the exhaust phase.

3. The method according to claim 1, wherein the ignition of the remaining fuel takes place at a maximum crank angle of 20° after the start of the injection of the remaining fuel.

4. The method according to claim 1, wherein characterized in that a pressure regulator directs fuel from a fuel tank at a set pressure via a distribution device to a plurality of injectors, and wherein during the shut-off process the pressure regulator terminates the fuel supply to the distribution device, preferably before the remaining fuel is injected and ignited.

5. The method according to claim 4, wherein during the switch-off process of the internal combustion engine, fuel located in a component selected from the group consisting of the distribution device and the injectors is injected into at least one cylinder of the internal combustion engine after the primary ignition and before the start of the subsequent inflow phase and is ignited.

6. The method of claim 1, wherein the internal combustion engine is operated in a four-stroke mode, wherein in the switched-on operating state during an intake stroke an oxygen-containing gas, which includes air, is introduced into the at least one cylinder and fuel is fed into the at least one cylinder, and wherein during the switch-off process the remaining fuel is injected into at least one cylinder of the internal combustion engine before the start of the intake stroke and is ignited.

7. The method according to claim 6, wherein in the switched-on operating state, exhaust gas is discharged from the at least one cylinder at the beginning of or during an exhaust stroke and wherein in that, during the switch-off process, the remaining fuel is injected into at least one cylinder of the internal combustion engine before the end of the exhaust stroke and is ignited.

8. The method according to claim 6, wherein during the switch-off process, the remaining fuel is injected and ignited at or after a crank angle of 30° before the start of the exhaust stroke.

9. The method according to claim 1, wherein the internal combustion engine is operated in a two-stroke mode.

10. The method according to claim 8, wherein in a switched-on operating state of the internal combustion engine, exhaust gas is discharged from the at least one cylinder during an exhaust phase, and wherein, during the switch-off process, injection of the remaining fuel begins at or after a crank angle of 15° before the start of the exhaust phase.

11. The method according to claim 1, wherein in a switched-on operating state of the internal combustion engine, exhaust gas is discharged from the at least one cylinder during an exhaust phase, and wherein the remaining fuel is injected and ignited during the switch-off process after the start of the exhaust phase.

12. The method according to claim 1, wherein in a switched-on operating state of the internal combustion engine, exhaust gas is discharged from the at least one cylinder during an exhaust phase, and wherein the remaining fuel is injected and ignited during the switch-off process in the exhaust phase.

13. The method according to claim 1, wherein in a switched-on operating state of the internal combustion engine, exhaust gas is discharged from the at least one cylinder during an exhaust phase, and wherein the remaining fuel is injected and ignited during the switch-off process in the first half of the exhaust phase.

14. The method according to claim 6, wherein during the switch-off process, the remaining fuel is injected and ignited at or after a crank angle of 20° before the start of the exhaust stroke.

15. The method according to claim 8, wherein in a switched-on operating state of the internal combustion engine, exhaust gas is discharged from the at least one cylinder during an exhaust phase, and wherein during the switch-off process, injection of the remaining fuel begins at or after a crank angle of 5° before the start of the exhaust phase.

16. The method according to claim 8, wherein in a switched-on operating state of the internal combustion engine, exhaust gas is discharged from the at least one cylinder during an exhaust phase, and wherein during the switch-off process, injection of the remaining fuel begins at or after the start of the exhaust phase.

17. The method according to claim 1, wherein the ignition of the remaining fuel takes place at a maximum crank angle of 10° after the start of the injection of the remaining fuel.
